(19) United States
(12) Patent Application Publication
(10) Pub. No.: US 2011/0007873 A1
(43) Pub. Date: Jan. 13, 2011

(54) IMAGING ARRAY DATA ACQUISITION SYSTEM AND USE THEREOF

(75) Inventor: Stephen Rudin, Williamsville, NY (US)

Correspondence Address: NIXON PEABODY LLP - PATENT GROUP, 1100 CLINTON SQUARE, ROCHESTER, NY, 14604, US

(73) Assignee: THE RESEARCH FOUNDATION OF STATE UNIVERSITY OF NEW

(21) Appl. No.: 12/867,018

(22) PCT Filed: Feb. 12, 2009
(86) PCT No.: PCT/US09/33874

§ 371 Date: Sep. 22, 2010

Related U.S. Application Data
(60) Provisional application No. 61/028,768, filed on Feb. 14, 2008.

(51) Int. Cl. G01N 23/04; H04N 7/18

(52) U.S. Cl. 378/62; 348/77; 348/E07.085

(57) ABSTRACT

The present invention relates to an imaging system, computer readable medium, and method for dynamic imaging of an object to be examined. The imaging system includes detection array comprising an array of modular devices positioned such that one or more modular devices are capable of simultaneously receiving at least a portion of a first output signal from an emission source of an object to be imaged, each of said modular devices comprising a detector device, wherein each of the modular devices in the array is capable of converting at least a portion of the first output signal to a second output readout. The imaging system further includes a processing unit operatively coupled to the detection array and capable of processing the second output readouts of one or more of the modular devices, wherein said processing comprises adjusting the relationship between any combination of a second output collection rate for each active modular device, a second output readout rate, a frame rate for each active modular device, binning factor, and a number of active modular devices determining an image field of view to maintain a total output data acquisition rate below a maximum data acquisition rate of the processing unit and to obtain an image of the object.

This application claims the benefit of U.S. Provisional Patent Application Ser. No. 61/028,768, filed Feb. 14, 2008, which is hereby incorporated by reference in its entirety.

### FIELD OF THE INVENTION

The present invention relates to a dynamic imaging system (i.e., for imaging moving objects), computer readable medium, and method for dynamic imaging.

### BACKGROUND OF THE INVENTION

With the onset of improved, patient-specific treatments for vascular disease and advancing diagnostic techniques, there is an increasing need for high-quality, high resolution images obtainable in real time (Rudin et al., “Endovascular Image-Guided Interventions (EIGIs),” Med. Phys. 35(1):301-309 (2008)). Current state-of-the-art medical x-ray image intensifiers (XII), the vacuum bottle electron multiplier imagers, that have dominated the real-time radiographic imaging field for over fifty years, have inherent limitations (Rudin et al., “Accurate Characterization of Image Intensifier Distortion,” Med. Phys. 18(6): 1145-1151 (1991)). They are physically cumbersome and suffer from various distortions as a result of the signal amplification process, including susceptibility to the Earth's magnetic field. As a result, XIIs are being replaced with flat panel detectors (FPDs).

There was supposed to be a revolution in rapid sequence radiographic-fluoroscopic imaging detectors when FPDs began to take the place of XIIs. The detection of x-rays with a thin layer of CsI(Tl) phosphor to convert the energy of each x-ray photon into visible light to be detected in turn by an imaging photo-sensor, a combination that is universally used in all XIIs, was still to be used in most FPDs (indirect FPDs). Thus, basic detection physics would be unchanged. Only the photo-sensor was changed. Direct FPDs, where the x-ray energy is converted directly into hole-electron pairs, were also tried before being relegated to back-burner status due to severe technical problems. The industry spent hundreds of millions of dollars developing FPDs, because they were supposed to eliminate XII geometric distortion, be physically smaller, with large dynamic range, less blooming or veiling glare, and less sensitivity to small magnetic fields as low as that of the earth's. Although FPDs are successfully replacing film-screen image receptors for static imaging where higher exposures per frame are needed, they have been somewhat disappointing for fluoroscopic applications where about 1/100th the x-ray exposure per frame is typically used and for angiography where spatial resolution improvement is not apparent.

The reason for the failure in fluoroscopy is that FPD developers have been unable to reduce the electronic noise that occurs when the electronic signal (derived from a photodiode at each pixel that views the phosphor's light and stored at a capacitor at each pixel) is transferred by the thin film transistor (“TFT”) switches, off the pixel, to amplifiers and digitizers at the edges of the FPD image sensing area. This fixed electronic noise does not compromise static radiographic images where the signal is 100× larger, but does impact fluoroscopy where the signal is comparable to the noise.

Preliminary research on schemes for providing increased gain at each pixel using additional amplifiers or exotic avalanche devices, or new direct photo-conductors, have been reported at scientific meetings for years; however, no practical solutions have been developed. The most advanced single photon counting non-FPD dynamic detectors are either optimized for low energy (3-15 keV) imaging (www.dectris.com) or use complex, non-standard, 256² pixel integrated circuits and cannot be practically projected to clinical use (Tlustos et al., “Imaging Properties of the Medipix2 System Exploiting Single and Dual Energy Thresholds,” IEEE Trans. Nucl. Sci. 53(1):367-372 (2006)). A few reported clinical single-photon units are slow scanning static imagers.

Thus, in FPDs, physicians are expected to accept degraded fluoroscopy in exchange for some improvement in radiographic or angiographic (higher exposure) images; however, these improvements do not include better spatial resolution. Even though the front end detection physics for the Cs(Tl) phosphor is unchanged compared to XIIs, high speed dynamic FPDs are limited in pixel sizes that can be manufactured to 150-200 μm, often with binning and temporal integration used for noise reduction. Whereas for XIIs, pixels below 110 μm are commonly available in magnification modes. Thus, to this day, fluoroscopy and high resolution angiography with XIIs can be better than with FPDs, even with all the expense of signal processing done only for FPDs (Cusma, “Interventional Fluoroscopy Imaging Equipment—What to Know Before You Buy,” 48^{th} Annual Meeting of the AAPM, Session WE-B-ValA-CE: Fluoroscopy Physics and Technology—III (Orlando, Fla., Aug. 2, 2006)).

Additionally, FPD developers have had to cope with unexpectedly difficult problems of lag and ghosting encountered during rapid sequence imaging where residual charge from previous images is superimposed on the current image being acquired, a problem that is not characteristic of XII systems where video cameras based on CCD image sensors do not exhibit such lag or ghosting. Nevertheless, even with such deficiencies, it is clear FPDs will increasingly be replacing XIIs (Kuhls-Gilcrist et al., “The Solid-State X-ray Image Intensifier (SSXII): An EMCCD-Based X-ray Detector,” Proc. Soc. Photo. Opt. Instrum. Eng. Medical Imaging 6913-19 (2008)).

In the meantime, the need for real-time x-ray imaging detectors is changing. As large, rapid multi-slice computed tomography (“CT”) scanners and high-field MRI machines produce superior minimally invasive studies that are beginning to replace more invasive fluoroscopic and angiographic x-ray procedures (where arterial punctures are needed), the requirements on rapid sequence x-ray detectors are changing. It is evident, for example, that fewer diagnostic coronary catheter procedures involving femoral arterial punctures will be needed when they are replaced by multi-slice CT coronary procedures where only a venous injection is required. Special procedure suites will be more devoted to image guided interventions (“IGI”) rather than to diagnosis. In particular, more of the time in angiographic suites will be used for minimally invasive and endovascular image guided interventions (“EIGI”), which will increasingly be replacing invasive surgical procedures. EIGI increase the demand for better quality in medical images such as higher spatial resolution, increased sensitivity, negligible lag, wider dynamic range, and higher frame rates (Keleshis et al., “LabVIEW Graphical User Interface for a New High Sensitivity, High Resolution Micro-Angio-Fluoroscopic and ROI-CBCT System,” Proc Soc Photo Opt Instrum Eng. 6913: 69134A (2008)). Thus, the requirements on dynamic x-ray imagers will be for increased spatial resolution to help guide the intervention more accurately while keeping the integrated radiation dose to the patient well below levels that might cause radiation damage.

For IGI, since the diagnosis is known, there is a need for improved image quality over the site of the intervention rather than across the full field of view (“FOV”). Thus, there will be a need for higher resolution imagery over a smaller field of view or region of interest (“ROI”), requirements that FPDs do not appear to be suited for (Ionita et al., “Implementation of a High-Sensitivity Micro-Angiographic Fluoroscope (HS-MAF) for In-Vivo Endovascular Image Guided Interventions (EIGI) and Region-of-Interest Computed Tomography (ROI-CT),” Proc. Soc. Photo. Opt. Instrum. Eng. 6918: 691811 (2008)).

Also, new applications such as cone-beam CT and mammographic tomosynthesis and mammo-CT are demanding large area image receptors with requirements that exceed the capabilities of present day FPDs for both high resolution and low noise especially if many CT projection views are required, each at close-to-low fluoroscopic-like exposures (Rudin et al., “New Light-Amplifier-Based Detector Designs for High Spatial Resolution and High Sensitivity CBCT Mammography and Fluoroscopy,” Proc. Soc. Photo. Opt. Instrum. Eng. 6142:61421 R (2006)).

Initial work has been reported with an electron-multiplying charge coupled detector (EMCCD)-based detector for imaging (Rudin et al., “New Light-Amplifier-Based Detector Designs for High Spatial Resolution and High Sensitivity CBCT Mammography,” Proc. Soc. Photo. Opt. Instrum. Eng. 6142:61421 R (2006); Kuhls et al., “Progress in Electron-Multiplying CCD (“EMCCD”) Based, High-Resolution, High-Sensitivity X-ray Detector for Fluoroscopy and Radiography,” In: Medical Imaging 2007: Physics of Medical Imaging, Hsieh et al., eds., Proc. of SPIE, vol. 6510, paper 6510-47 (2007); Kuhls et al., “Linear Systems Analysis for a New Solid State X-ray Image Intensifier (SSXII) Based on Electron-Multiplying Charge-Coupled Devices (EMCCDs) (abstract),” Medical Physics, WE-C-L100J-6 (2007); Kuhls et al., “The New Solid State X-ray Image Intensifier (SSXII): A Demonstration of Operation Over a Range of Angiographic and Fluoroscopic Exposure Levels (abstract),” Medical Physics, WE-C-L100J-3 (2007); Rudin et al., “The Solid State X-ray Image Intensifier (SSXII): A Next-Generation High-Resolution Fluoroscopic Detector System (abstract),” Medical Physics, WE-C-L100J-4 (2007)).

Other have used EMCCDs for single gamma-ray photon counting (Beekman et al., “Photon-Counting Versus an Integrating CCD-based Gamma Camera: Important Consequences for Spatial Resolution,” Phys. Med. Biol., 50: N109-119 (2005); de Vree et al., “Photon-Counting Gamma Camera Based on an Electron-Multiplying CCD,” IEEE Trans. On Nucl. Sci., 52(3):580-588 (2005)), for high dose x-ray (Badel et al, “Performance of Scintillating Waveguides for CCD-based X-ray Detectors,” IEEE Trans. Nucl. Sci., 53(1):3-8 (2006)), and for SPECT/CT scanners (Nagarkar et al., “Design and Performance of an EMCCD Based Detector for Combined SPECT/CT Imaging,” IEEE Nucl. Sci. Symp. Conf. Record, M07-254, pp 2179-2182 (2005); Miller et al., “Single-Photon Spatial and Energy Resolution Enhancement of a Columnar CsI(Tl)/EMCCD Gamma-Camera Using Maximum-Likelihood Estimation,” Proc. of SPIE Physics of Medical Imaging, Vol. 6142, 61421T-1 (2006); Thacker et al., “Characterization of a Novel MicroCT Detector for Small Animal Computed Tomography (CT),” In Medical Imaging 2007: Physics of Medical Imaging, Hsieh et al., eds., Proc. of SPIE, Vol. 6510, paper 6510-131 (2007)) where the high gain was apparently used for the SPECT and low gain for the CT acquisition.

The concept of tiling of CCD-based detectors in an array is not new (Rudin et al., “Rapid Scanning Beam Digital Radiography,” J. Imaging Technology (formerly J. Appl. Photog. Engin.) 9(6):196-198 (1983); Hamamatsu Corp., “FOS, Fiber-optic Plate with X-ray Scintillator,” p. 7, example 2 in pamphlet, Cat. No. TMCP1014E03 (1999); Kutlubay et al., “Cost-Effective, High Resolution, Portable, Digital X-ray Imager,” SPIE vol. 2432, pp. 554-562, In: Proceedings from Medical Imaging 1995: Physics of Medical Imaging, San Diego, Calif. (1995); Kutlubay et al., “Portable Digital Radiographic Imager: An Overview,” SPIE vol. 2708, pp. 742-749, In: Proceedings from Medical Imaging (1996): Physics of Medical Imaging, Newport Beach, Calif. (1996); Smith et al., “Parallel Hardware Architecture for CCD-Mosaic Digital Mammography,” SPIE vol. 3335, pp. 663-674, In: Proceedings from Medical Imaging 1998: Medical Display, San Diego, Calif. (1998); Stanton et al., “CCD-Based Detector for Full-field Digital Mammography,” Proc. of SPIE, Vol. 3659, pp. 740-748, Medical Imaging (1999): Physics of Medical Imaging, Boone et al., eds., (1999)). A project by Bennett Corp. (now Hologic) used CCD array detectors (Williams et al., “Image Quality in Digital Mammography: Image Acquisition,” J Am Coll Radiol., 3:594 (2006)) for demonstrating to the FDA clinical efficacy of digital mammography. They then substituted their presently-marketed direct FPD as equivalent so as to reach the market more quickly. A tiled CCD-based rapid-sequence fluoroscopy-capable detector is disclosed in Vedanthan et al., “Solid-State Fluoroscopic Imager for High Resolution Angiography, Physical Characteristic of an 8 cm×8 cm Experimental Prototype,” Medical physics, 31(6):1462-1472 (2004) and uses an abutted array of very large special CCDs without minifying fiber optic tapers. Such CCD-based detectors, however, are not suitable for dynamic imaging.

The present invention is directed to overcoming these and other deficiencies in the art.

### SUMMARY OF THE INVENTION

The present invention relates to an imaging system including a detection array comprising an array of modular devices positioned such that one or more modular devices are capable of simultaneously receiving at least a portion of a first output signal from an emission source of an object to be imaged, each of said modular devices comprising a detector device, wherein each of the modular devices in the array is capable of converting at least a portion of the first output signal to a second output readout. The imaging system further includes a processing unit operatively coupled to the detection array and capable of processing the second output readouts of one or more of the modular devices, wherein said processing comprises adjusting the relationship between any combination of a second output collection rate for each active modular device, a second output readout rate for each active modular device, a frame rate for each active modular device, binning factor, and a number of active modular devices determining an image field of view to obtain an image of the object.

Another aspect of the present invention relates to an imaging method. The method includes positioning a detection array to receive a first output signal from an emission source of an object to be imaged, wherein the detection array comprises an array of modular devices positioned such that one or more modular devices are capable of simultaneously receiving at least a portion of the first output signal, each of said modular devices comprising a detector device. The method further includes converting at least a portion of the first output signal to a second output readout with one or more of the modular devices. In addition, the method includes processing the second output readouts of one or more of the modular devices, wherein said processing comprises adjusting the relationship between any combination of a second output collection rate for each active modular device, a second output readout rate for each active modular device, a frame rate for each active modular device, binning factor, and a number of active modular devices determining an image field of view to obtain an image of the object.

A further aspect of the present invention relates to a computer readable medium having stored thereon instructions for imaging an object including machine executable code which when executed by at least one processor, causes the processor to perform steps including receiving a second output readout from one or more modular devices in a detection array, wherein the detection array comprises an array of the modular devices positioned such that each modular device is capable of simultaneously receiving at least a portion of a first output signal from an emission source of an object to be imaged, each of said modular devices comprising a detector device, wherein each of the modular devices in the array is capable of converting at least a portion of the first output signal to the second output readout. The second output readouts of one or more of the modular devices are processed, wherein said processing comprises adjusting the relationship between any combination of a second output collection rate for each active modular device, a second output readout rate for each active modular device, a frame rate for each active modular device, binning factor, and a number of active modular devices determining an image field of view to obtain an image of the object

The imaging system, computer readable medium, and method of the present invention exhibit clear advantages over flat-panel devices and x-ray image intensifiers of the prior art. These advantages include higher spatial resolution with smaller pixels, lower instrumentation noise hence better operation at lower exposure, huge dynamic range due to adjustable on-chip gain, no lag, no ghosting, and scalable production based on existing solid state technology. The imaging system, computer readable medium, and method of the present invention have wide-reaching application to substantially improving the accuracy of both diagnosis and minimally invasive treatment of cardiovascular disease, stroke, and cancer, the three leading causes of death and disability. Both improved dynamic temporal resolution and much higher spatial resolution imaging than are presently available as well as new modalities of region of interest fluoroscopy, angiography, and computed tomography will be enabled at substantially lower integral patient radiation doses. Improved diagnostic imaging procedures and more accurate image guided minimally invasive treatments have positive implications not only toward improving health care but also toward reducing health care costs.

### BRIEF DESCRIPTION OF THE DRAWINGS

FIG. 1 is a block diagram of an imaging system of one embodiment of the present invention with two exemplary detector devices and associated analog-to-digital converters shown for ease of illustration.

FIG. 2 is a schematic of a 2×2 detection array of the present invention including four modular devices of the present invention. In this figure, for ease of illustration, the detector device and other elements of the modular device (e.g., cooling device) are shown as a rectangular solid.

FIG. 3 is a drawing of a modular device of the detection array of FIG. 2, including an EMCCD detector and showing one embodiment with a 5:1 fiber-optic taper (FOT) resulting in 40 μm pixels. Because the chip is a frame-transfer EMCCD, it is capable of 30 frames per second (fps) acquisition rates.

FIGS. 4A-B are schematics of a network design of a buffer and gating circuitry for an imaging system of the present invention. In FIG. 4A, gates associated with modular device one are enabled, then in time slot 2 (FIG. 4B) only gates for modular device two are enabled until finally in time slot 9 (not shown) only gates for modular device nine are enabled. Only 12 of 16 input lines for the digital signal processor are used. Not all lines are drawn to simplify the drawing.

FIG. 5 is a schematic diagram illustrating one embodiment of the imaging system and method of the present invention.

FIG. 6 shows a standard mammographic bar pattern taken at 50 kVp through one inch thick acrylic with 2×2 binning (16 μm pixels).

FIGS. 7A-B show an identical set up using 70 kVp; 160 mA; 45 ms; 2″ PMMA filtration; 0.3 mm focal spot for both a solid state x-ray image intensifier (SSXII) (FIG. 7A) with 16 μm pixels and an XII (FIG. 7B) with 114 μm pixels (4.5″ mode).

FIGS. 8A-D show a multi-link PIXEL coronary stent system (Guidant, Temecula, Calif.); 1 mm×28 mm (crimped, but when expanded will be 2.5 mm) taken at 70 kVp through two inches of acrylic with an SSXII of the present invention (FIGS. 8A and C) and XII (FIGS. 8B and D) for angio mode (FIGS. 8A and B) 2 fps, 50 mA, 10 ms and fluoro mode (FIGS. 8C and D) 7.5 fps, 10 mA, 3.3 ms.

FIG. 9A shows experimental modulation transfer function (MTF) and FIG. 9B shows detective quantum efficiency (DQE) of a prototype SSXII. DQE is measured for a range of detector exposures from 2.34 μR to 1.41 mR.

FIGS. 10A-I show a set of EMCCD images where the digital values are maintained because the EMCCD gain is changed inversely with the exposure. Quantum noise increases so that there is less visualization as exposure decreases. Comparisons with two sample XII images (FIGS. 10J and K) are also provided for the highest image receptor exposure and for a lower cine frame exposure. The phantom consisted of, from left to right, 100 μm Au wire, 50 μm Pt stretched coil wire (Guglielmi Detachable Coil) of the type used for cerebral aneurysm embolization, 100 μm iodine filled capillary with Reno-60 contrast agent (28% organically bound iodine), and a modified Multi-Link ZETA Coronary Stent (diameter: 2.75 mm, length: 23 mm) with a polyurethane low porosity region delineated by small Pt markers used for localizing the low porosity patch of the asymmetric stent over an aneurysm orifice to occlude it. The x-ray spectrum was IEC RQA 5 standard, using 21.4 mm Al filtration and 74 kVp and the EMCCD was binned 2×2 to result in 16 μm pixels while the XII was in highest magnification mode (5 inch). No temporal filtering was used for any of the images.

FIG. 11 shows a bar pattern image formed using a prototype CCD imaging system built from components.

### DETAILED DESCRIPTION OF THE INVENTION

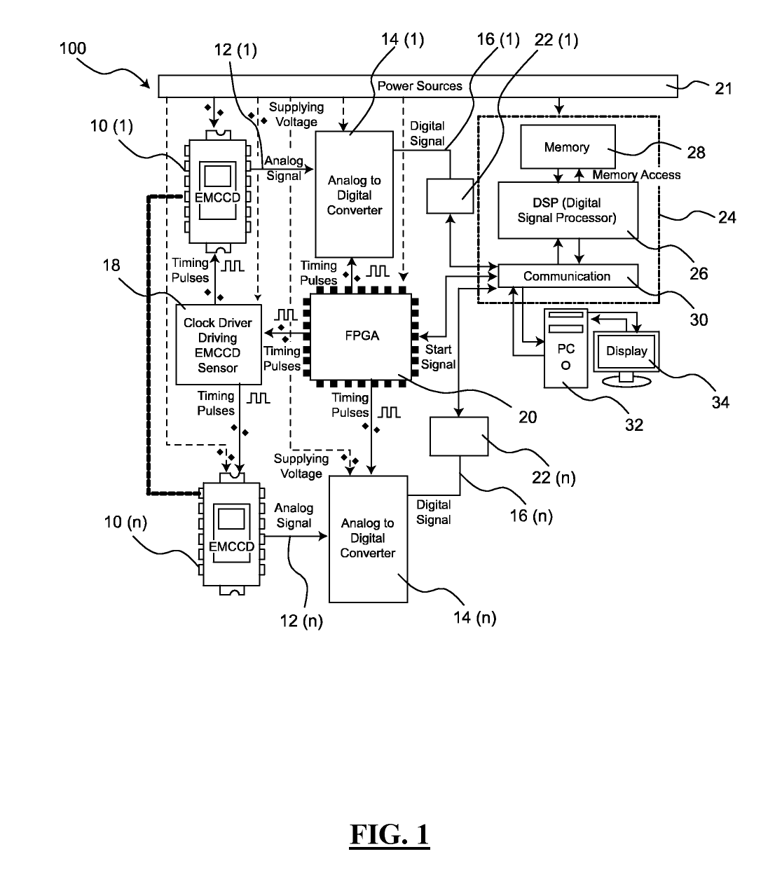

The present invention relates to a dynamic imaging system, computer readable medium, and dynamic imaging method. A system 100 which obtains an image of an object to be examined and maintains a total output data acquisition rate below a maximum data acquisition rate of the processing unit is shown in FIG. 1. The system includes a plurality of detector devices 10(1)-10(n) which, as described in detail below, are formed in a detection array comprising an array of modular devices. For ease of illustration in FIG. 1, the detector devices are shown individually and not in the array format.

In the embodiment shown in FIG. 1, the detector device 10(1)-10(n) is an electron multiplying charge coupled device (“EMCCD”). However, any other suitable detector device 10(1)-10(n) designed to detect a first output signal from an emission source of the object to be imaged may be used. Other suitable detector devices 10(1)-10(n) include, but are not limited to, charge coupled devices (“CCDs”), photodiode arrays, phototransistor arrays, photomultiplier tubes, and avalanche photodiode arrays. An EMCCD is capable of converting at least a portion of the first output to an amplified, electronic second output readout. EMCCDs are relatively new sensors that have all the benefits of standard CCDs (high resolution, high speed, low noise, no lag) with the addition of on-chip gain created by an extra row of hundreds of special multiplying elements. Adjustment of a low voltage (tens of volts) applied to these electron multiplying elements provides on-chip gains from 1 to greater than 1000×.

To achieve the higher gain needed to overcome the low signal experienced during fluoroscopy, a device is needed that can amplify the signal by about two orders of magnitude and yet, unlike light amplifiers, can operate at low voltages, be manufactured with industry standard solid state lithographic techniques, and be used to build a modular device that can be expanded into a full field of view array. EMCCDs are such devices (Hynecek J, “Impactron—A New Solid State Image Intensifier,” IEEE Transactions on Electron Devices, 48(10):2238-2241 (2001), which is hereby incorporated by reference in its entirety). In standard CCDs, a “bucket brigade” of charge derived from the exposure of the CCD to light, passes from pixel to pixel toward the output. For EMCCDs, an additional row of special multiplier registers is inserted at the end, before the final amplifier and analog-to-digital (“A to D”) converter. For each of these registers a somewhat higher switching voltage of about 20 volts is used to cause a small gain of up to 1 to 2%; however, there are 400 or more of these in series after the row transfer and all the charge packets see this gain. The resulting total amplification for example for a 1.75% gain at each register is then 1.0175⁴⁰⁰=1032 which is perhaps 10× more than needed in the present invention. For radiographic mode where the signal starts out larger, the EMCCD gain may be set low or even to one and the EMCCD would be made to perform as a standard CCD. Although it was initially feared that having gain from such a long chain of amplifiers might increase the noise in the output by √2 (Robbins et al., “The Noise Performance of Electron Multiplying Charge-Coupled Devices,” IEEE Transactions on Electron Devices, 50(5):1227-1232 (2003), which is hereby incorporated by reference in its entirety), that is indeed the case only when the input are uncorrelated light photons. For use in x-ray detectors, the light comes to the EMCCD from the phosphor in packets as each x-ray's energy is converted to a group of photons. Although the gain in each multiplier element might fluctuate somewhat, the total number of packets would not, since this number is determined by the number of x-rays absorbed. Thus, when the EMCCDs are set to a gain of one, there should not be any additional noise compared to when standard CCDs are used (such as during angiographic modes) because this gain fluctuation is secondary to the quantum mottle of the x-rays.

Referring to FIG. 1, the detector devices 10(1)-10(n) in each modular device receive the first output signal (not shown) and convert at least a portion of the first output signal into a second output readout 12(1)-12(n) (e.g., an electronic signal), which is then analog-to-digital converted. Thus, the embodiment of the imaging system shown in FIG. 1 further includes one or more analog-to-digital converters 14(1)-14(n) operatively coupled with the detector devices 10(1)-10(n) and capable of converting each of the second outputs 12(1)-12(n) to a digital output 16(1)-16(n) comprising multiple units of data.

As shown in FIG. 1, in this embodiment, the detector device 10(1)-10(n) is plugged into the mother-board, which has a clock driver circuit 18 and on which is a mounted a field-programmable gate array (“FPGA”) 20 used to control the clocking pulses for the detector device control and readout. As described in detail below, the clock driver circuit 18, as controlled by the processing unit, can be used to control processing of the detector devices 10(1)-10(n) such that all data from each modular device can be read sequentially, individual data units from each modular device can be read sequentially, or data from a subgroup of modular devices can be read. Also, as shown in FIG. 1, power sources 21 provide power for all of the components of the system.

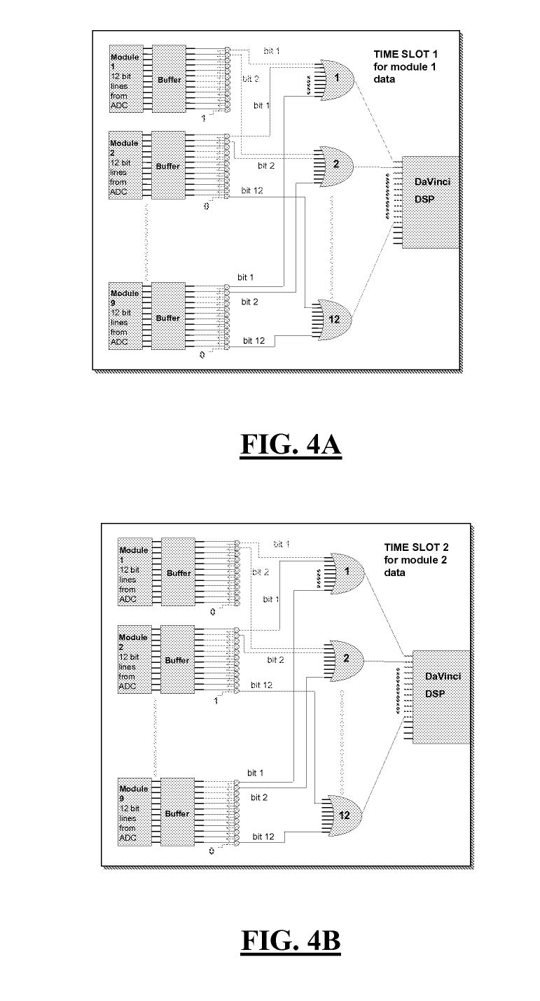

Referring to FIG. 1, the imaging system 100 further includes A to D buffering and gating circuitry 22(1)-22(n), described in more detail below with regard to FIGS. 4A-B, and a processing unit 24 capable of processing one or more of the digital outputs 16(1)-16(n) of one or more of the modular devices, wherein processing comprises adjusting the relationship between any combination of second output collection rate for each active modular device, second output readout rate for each active modular device, frame rate for each active modular device, binning factor, and the number of active modular devices determining an image field of view to maintain a total output data acquisition rate suitable for dynamic imaging (e.g., 1000×1000 matrices at 30 frames per second (fps)). Although one processing unit is shown in FIG. 1, the system 100 can have other numbers and types of processing units.

The processing unit 24 includes a digital signal processor 26 (or central processing unit (CPU)), a memory 28, and an interface system 30 which is operatively connected to the one or more A to D converters 14(1)-14(n) such that digital output (e.g., in the form of a 12 Bit or 16 Bit digital signal) is routed from the A to D converters 14(1)-14(n) to the digital signal processor 26. Each of the components of the processing unit, as well as a user input device and display, as described in more detail below, are coupled together by a bus or other link, although the processing unit (and user input device and display) can include other numbers and types of components, parts, devices, systems, and elements in other configurations. The processor 26 in the processing unit 24 executes a program of stored instructions for one or more aspects of the present invention as described and illustrated herein, although the processor could execute other numbers and types of programmed instructions.

The memory 28 in the processing unit 24 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory in the processing unit 24.

The interface system in the processing unit 24 is used to operatively couple and communicate between the processing unit 24 and the analog-to-digital converters 14(1)-14(n), FPGA 20, buffer and gating circuitry 16(1)-16(n), and user input device 32, although other types and numbers of connections and configurations can be used.

As shown in FIG. 1, the system further includes a user input device 32 and display device 34 operatively connected for control and readout of the digital output. The user input device 32 is used to input selections, such as gain control, roadmapping, and various zoom and region of interest modes, although the user input device could be used to input other types of data and interact with other elements. The user input device can include a computer keyboard and a computer mouse, although other types and numbers of user input devices can be used. The display 34 is used to show data and information to the user, including the image of the object to be examined, and, in one embodiment, has a graphic user interface (“GUI”). The display can include a computer display screen, such as a CRT or LCD screen, although other types and numbers of displays could be used.

The GUI may include controls for manual and automatic gain control, roadmapping, and various zoom and region of interest modes. In one embodiment, a LabVIEW (National Instruments, Dallas, Tex.)-software-based GUI provides control over the imaging system during use, for example, during fluoroscopy with roadmapping and angiography acquisitions. The software enables all the necessary features of acquisition, processing, storage, and display including capabilities to do digital subtraction angiography (DSA) and roadmapping. A suitable GUI which can be modified for the present invention is described, for example, in Keleshis et al., “LabVIEW Graphical User Interface for a New High Sensitivity, High Resolution Micro-Angio-Fluoroscopic and ROI-CBCT System,” Proc. Soc. Photo. Opt. Instrum. Eng., 6913:69134A (2008), which is hereby incorporated by reference in its entirety.

Although embodiments of the processing unit 24 are described and illustrated herein, the processing unit 24 can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more processing systems or devices can be substituted for the processing unit in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

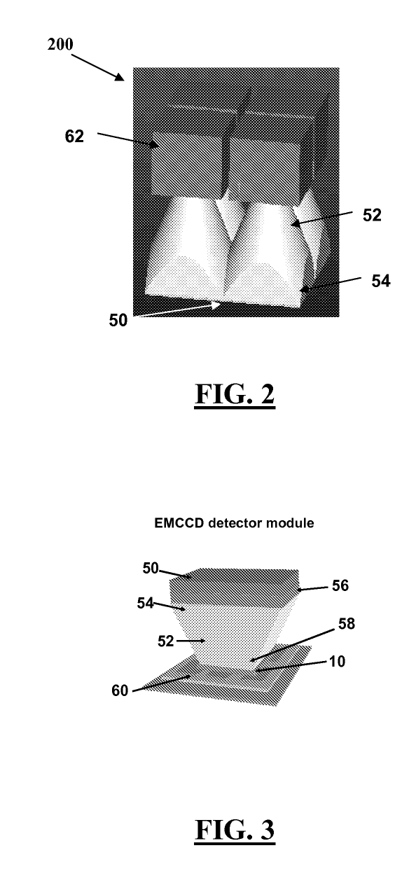

As described above and referring to FIG. 2, the detection array 200 in the system 100 of the present invention comprises an array of modular devices positioned such that one or more modular devices are capable of simultaneously receiving at least a portion of a first output signal from an emission source 50 of an object to be imaged, each of said modular devices comprising a detector device, wherein each of the modular devices in the array is capable of converting at least a portion of the first output signal to a second output readout. In one embodiment, the second output readout is an electronic signal. Thus, in accordance with the present invention, an array of information gathering modular devices are provided which receive and convert the first output, wherein the array covers an area defining a field of view. The area may be a linear array (1×2, 1×3, etc.) or a two-dimensional array (2×2, 3×3, etc.). A schematic of a single modular device in accordance with one embodiment of the present invention is shown in FIG. 3.

Referring to FIGS. 2 and 3, the emission source 50 provides a first output from an object to be imaged. In the embodiment shown in FIGS. 2 and 3, the emission source 50 is a radiation converter which converts radiation received from an object to be examined and provides a first output. The radiation can be any desired particulate or wave radiation, including the entire electromagnetic spectrum, such as x-ray. When used with an x-ray source, the emission source 50 may include an x-ray converter capable of receiving the x-rays which pass through the object to be imaged and converting the received x-rays into the first output (e.g., light). In one embodiment, the emission source is a CsI(Tl) phosphor x-ray converter which converts x-rays into light. In another embodiment, the emission source is a CsI(Tl) phosphor of from about 100 μm to about 600 μm in thickness. Other suitable emission sources include, but are not limited to, charge from a direct x-ray converter layer, such as amorphous selenium, mercuric iodide, or lead oxide. Alternatively, the object being imaged may, itself, be the source of the first output.

Referring to FIGS. 2 and 3, in this embodiment, each of the modular devices includes a fiber optic taper 52 having a first end positioned to receive the first output and a second end optically coupled with the detector device. As shown in FIG. 3, the large end (i.e., first end) 54 of fiber optic taper 52 is proximate the emission source 50, in this case a CsI(Tl) phosphor x-ray converter. Referring to FIG. 3, the emission source 50 is coupled by a fiber optic plate (FOP) 56 to the large end 54 of the fiber optic taper 52, which is in turn coupled to the detector device 10 at the small end (i.e., second end) 58 of the fiber optic taper 52. In a further embodiment, as shown in FIG. 3, the modular devices may include a cooling device 60, such as a Peltier cooler.

Alternatively, as shown in FIG. 2, the emission source 50, e.g., x-ray converter, may be directly deposited on the large end 54 of the fiber optic taper 52. Referring to FIG. 2, the detector device and other elements of the modular device (e.g., cooling device) are shown as a rectangular solid 62 for ease of illustration. In another embodiment, the small end 58 of the fiber optic taper may be coupled with the detector device 10 by another FOP (see, also, Rudin et al., “New Light-Amplifier-Based Detector Designs for High Spatial Resolution and high Sensitivity CBCT mammography and Fluoroscopy,” Proc. Soc. Phot. Opt. Instrum. Eng., 6142:61421 R (2006), which is hereby incorporated by reference in its entirety). The fiber optic taper focuses light from the emission source (e.g., a structured phosphor x-ray converter, such as CsI(Tl)) onto the detection device (e.g., an EMCCD). In one embodiment, the taper ratio for the fiber optic taper is from about 2:1 to about 6:1.

As described herein, in the system, computer readable medium, and method of the present invention the second output readout from one or more of the modular devices is subjected to processing including adjusting the relationship between any combination of a second output collection rate for each active modular device, a second output readout rate for each active modular device, a frame rate for each active modular device, binning factor, and a number of active modular devices determining an image field of view to maintain a total output data acquisition rate below a maximum data acquisition rate of the processing unit and to obtain an image of the object.

As used herein, the second output collection rate is the rate of signal collection from each pixel within the detector device in each active modular device. Thus, the second output is the charge collected at each pixel of the EMCCD. If binning is enabled in the EMCCD, then the rate of signal collection from the pixels of the EMCCD, prior to on-chip amplification and readout, can be increased. Binning is a data pre-processing technique wherein original data values which fall in a given small interval are replaced by a value representative of that interval. In an EMCCD, binning results from the summation of the charge from adjacent pixels in the EMCCD into a representative pixel. Binning is implemented quickly and easily by changing the control voltage waveforms applied to the EMCCD so that the charge in adjacent pixels are added. For the vertical direction for example, the charge in two or more rows are shifted to the readout register where they are added and then as the charges are shifted either through the multiplication register in the case of an EMCCD or directly to the readout amplifier, adjacent elements are again added before the readout and analog-to-digital conversion occurs. Binning can be performed quickly on the EMCCD itself hence reducing the amount of data in each detector device and speeding up the second output collection rate. In this way, second output signal collection rate for each active modular device could change while the data acquisition rate for each active modular device could stay constant. Thus, by enabling on-chip binning, dynamic or even real-time imaging (30 fps) can be performed where, for example, the digital data acquisition rate after A to D conversion or bandwidth, frame rate, and number of active modular devices are fixed. Although modification of the second output collection rate is described above with regard to EMCCDs, binning can be achieved in other suitable detector devices, such as CCDs. In addition, the second output collection rate of each modular device can be increased without changing binning by speeding up the collection timing pulses.

As used herein, the second output readout rate is the rate of signal transfer of the signal from the detector device in each modular device to the A to D converter. Thus, the second output readout is the signal received by the A to D converters (and then the processing unit) after on-chip amplification and readout by the EMCCD. The readout rate from the detector device (e.g., EMCCD) is controlled by the FPGA, which is programmed by the processing unit.

As used herein, the frame rate is the number of images acquired into the processing unit. The frame rate for each active modular device may be the same or different than the frame rate of the detection array. For example, if the information from the central modular devices is more critical than that from the peripheral modular devices, then the frame rate in the central modular devices may be greater than the frame rate for the peripheral modular devices and the frame rate for the whole detection array would be a essentially the same as the fastest modular device. The frame rate for each detector device is controlled by timing pulses by an FPGA. The processing unit programs the FPGA and the pulses from it are made the appropriate shape, voltage, and power by the drivers to be sent to the detector device (e.g., EMCCD). To change the frame rate for different modular devices, the FPGA is programmed as described above, and the driver pulses are gated appropriately (i.e., different modular devices receive different timing pulses). Thus, in one embodiment, the clock driver would include logic to enable gating of driver pulses to individual detector devices (e.g., EMCCDs). In another embodiment, the frame rate of the detection array is no more than 30 frames per second, which is suitable for dynamic imaging.

As used herein, binning factor refers to binning which occurs after the second output has been digitized and the data acquired in the processing unit (or computer system). In this case, the second output collection rate and total output data acquisition rate (the rate at which data from the detection array, after each modular device's second output readout has been digitized, is acquired by the processing unit) would not be altered, but binning in the processing unit results in a decrease in the amount of data for each active modular device. As the image is represented by a matrix in the processing unit, binning in the processing unit can be achieved by adding adjacent matrix elements, as known to those of ordinary skill in the art. Thus, by enabling binning in the processing unit (i.e., after digitization), dynamic or real-time imaging can be performed where, for example, the second output collection rate, data acquisition rate or bandwidth, and frame rate are fixed.

As used herein, active modular devices are the modular devices that participate in the formation of the images or frames being acquired at any time and hence could be any number between one and the total number of modular devices in the array. Increasing or decreasing the number of active modular devices affects the field of view (FOV), which is defined as the area being imaged. By reducing the number of active modular devices, dynamic or real-time imaging (with high resolution images) can be performed where, for example, the second output collection rate is lower (e.g., no binning has been applied on the detector device) and binning factor, frame rate, and data acquisition rate are fixed.

As used herein, the data acquisition rate is the rate at which data from the detection array, after each modular device's second output readout has been digitized, is acquired by the processing unit. In one embodiment, the data acquisition rate is from about 2 Mega words per second to about 30 Mega words per second, where each word is about two bytes, to enable dynamic or even real-time imaging. For a 1000×1000 pixel frame, these rates are equivalent to about 2 to about 30 frames per second.

As described above, processing comprises adjusting the relationship between any combination of second output collection rate for each active modular device, second output readout rate for each active modular device, frame rate for each active modular device, binning factor, and the number of active modular devices determining an image field of view. Each of these factors may be modified as described above through instructions from the processing unit. In order to obtain the desired image, one or more of these factors may be increased or decreased relative to one or more of the remaining factors. For example, in one embodiment, the frame rate, binning factor, and data acquisition rate or bandwidth are constant and processing includes increasing the second output collection rate by increasing binning (on the detector device) and increasing the number of active modular devices. In another embodiment, the frame rate, binning factor, and data acquisition rate or bandwidth are constant and processing includes decreasing the second output collection rate by decreasing binning (on the detector device) and decreasing the number of active modular devices. In yet another embodiment, the number of active modular devices and data acquisition rate or bandwidth are constant and processing includes increasing the second output collection rate by increasing binning (on the detector device) and increasing the frame rate.

In one embodiment, the processing unit reads a first unit of digital output of each modular device sequentially followed by each remaining unit of digital output of each modular device sequentially under conditions effective to obtain an image within the field of view. In another embodiment, the processing unit reads a total digital output for a first modular device followed sequentially by the digital outputs for each remaining modular device. In yet another embodiment, the processing unit reads digital outputs of a portion of the modular devices under conditions effective to obtain a high resolution image of a region of interest within the field of view.

In particular, when reading the digital outputs of all of the modular devices to acquire the total field of view, appropriate binning can be used (either within the detector device in each modular device or within the processing unit) to maintain the data acquisition rate within a desired range, e.g., about 30 MHz, which would be equivalent for 1000×1000 frames to no more than 30 fps, suitable for dynamic imaging. For angiography, suitable data acquisition rates are from about 2 to about 30 fps for 1000×1000 pixel frames. For fluoroscopy, suitable data acquisition rates are typically from about 7 to about 30 fps, preferably from about 15 to about 30 fps for 1000×1000 pixel frames. Thus, in one embodiment, the processing unit can readout each full modular device (in appropriately binned mode) sequentially. In another embodiment, the processing unit can readout one pixel or row at a time from each modular device (in appropriately binned mode) in turn. Alternatively, when reading the digital output of only a portion of the modular devices, e.g., one modular device, the portion of modular devices may be activated at the full resolution (i.e., without binning) as long as the total data acquisition rate or bandwidth is within the desired range. This allows a higher resolution image of a region of interest to be obtained within the area covered by that portion of modular devices. The processing unit can be programmed to perform in any of the above ways and the resolution versus field of view relationship can be easily altered without procedural disruptions. As long as the total data acquisition rate or bandwidth is kept the same, it does not matter in what sequence the active modular devices are readout as long as data binning is enabled, hence reducing the amount of data from each active modular device, to make up for the increased data coming from the extra modular devices to be readout. As described above, in one embodiment, binning can be done in the detector device (e.g., EMCCD or CCD) prior to digitization of the signal. In another embodiment, binning can occur in a processing unit after digitization. In this way, dynamic or even real-time imaging (30 fps) with variable resolution versus field-of-view balance, depending on the data acquisition rate or bandwidth available, can be performed.

One embodiment of a network design such that the processing unit reads a first unit of the digital output of each modular device sequentially followed by each remaining unit of the digital output of each modular device sequentially under conditions effective to obtain an image within the field of view is shown in FIGS. 4A-B. The basic concept for the network in FIGS. 4A-B is that for lower resolution large field of view images, generally, the pixels will be binned at the chip level so that, although there are many modular devices involved, the data transfer requirements for the network (to take the data from the modular devices and combine them in the computer to form and display the total image with a total data acquisition rate or bandwidth of 30 MHz, equivalent for about 1000×1000 pixel frames to less than 30 frames per second) are achievable with currently available components. For high resolution region of interest (ROI) imaging modes, a smaller number of modular devices will be active. Thus, the data transfer rate for these active modular devices will be quite high; however, most of the other modular devices that are not involved in the image acquisition, because they are outside the ROI, will be inactive. Accordingly, the network data transfer requirements to form a final image of a given matrix size will not vary much with resolution since the FOV will be reduced as the resolution is increased.

Referring to FIGS. 4A-B, A to D buffering and gating circuitry 22(1)-22(9) are shown, wherein parts of the total field of view are acquired with all active modular devices in appropriately binned mode so as to keep the total data acquisition rate or bandwidth no more than 30 MHz or the equivalent of 30 fps for frames of 1000×1000 pixel. The buffering and gating segments include a buffer and gating structure, including OR gates, for each modular device. In FIGS. 4A-B it is assumed that each modular device's data is 12 bit A-D converted; however, 16 bit A-D conversion is possible and the network would work much the same. In the embodiment shown in FIGS. 4A-B, each modular device is read, one 12 bit pixel at a time, sequencing through all the modular devices, before going to the next pixel. The data outputs from all the modular devices are gated so that only gates that are enabled at any one time can pass their data on eventually going to OR gates. All the same bit lines from all the modular devices are input to an OR gate whose output goes to the appropriate bit input of the processor development board for rapid processing and storage. Specifically, for a 3×3 array of 9 modular devices, all 12 bit data lines from modular device 1 are enabled while all other modular devices' lines are disabled. After the appropriate clock cycles, the data lines for modular device 2 are enabled while those of all the other modular devices are disabled. All nine modular devices are sequentially enabled. By the end of the sequence, the next pixel data is ready on modular device 1 so the sequence is begun again until all the pixels in all the modular devices are acquired. Because, this embodiment, there are nine modular devices, one must bin 3×3 to maintain 30 fps with a final composite 1000×1000 pixel frame. In a preferred embodiment, the development board is a DaVinci TMS320DM446 development board, with an acquisition rate of 75 MHz (recently increased to 85 MHz) and 16 input lines, to allow migration from 12 pixel data to 16 bit without having to change the basic architecture (beside the addition of more gates and 16 bit ADCs). This architecture can also be generalized to larger arrays of modular devices as long as the assumptions about overall data acquisition rate or bandwidth are preserved. Smaller sub-arrays can be activated, such as 2×2 arrays each with 2×2 binning. By appropriate software control of the enable lines, one can also select any of the modular devices at full resolution.

The network of gates can be constructed using individual off-the-shelf integrated circuits (ICs) (e.g., 74HC Advanced High Speed CMOS (AHC) series (100 MHz, 8.5 ns, 0.1 mW)) or custom-designed ICs using methods known to those of ordinary skill in the art.

The fact that the imaging system of the present invention is composed of an array of modular devices leads to a potential alignment problem. Each of these modular devices has associated with it, a matrix or tile that will probably be translated and rotated a small amount relative to the other modular devices because of the difficulty in positioning the detector devices (e.g., EMCCDs) precisely. Additionally, each of the modular devices will acquire images that exhibit some fixed distortion due to the fiber optic taper. Methods to correct all three of these problems are discussed in Hamwi et al., “Distortion and Orientation Correction of Tiled EMCCD Detector Images,” Proceeding of CARS 2007, Berlin, GE, Jun. 27-30, (2007) and Hamwi et al., “Distortion, Orientation, and Translation Corrections of Tiled EMCCD Detectors for the New Solid Sate X-ray Image Intensifier (SSXII),” Proc. of SPIE, 6913:69133 T1-11 (2008), which are hereby incorporated by reference in their entirety.

In one embodiment, when the detector device in each of the modular devices comprises an EMCCD, the gain of the EMCCDs can be varied during the course of imaging a field of view that might be quite inhomogeneous. Thus, some modular devices might experience a sudden gain change in order to make up for a large change in the incident fluence. For example, it is possible to place a semi-absorbing metallic filter between an x-ray source and the patient or object to reduce irradiation outside a region of interest yet maintain the full radiation dose within the region-of-interest. A poorer quality outside the region-of-interest would be acceptable, hence it is acceptable to reduce the exposure on the area outside the region of interest. From the detector's point of view, the signal is decreased outside the region-of-interest; hence additional EMCCD gain could be helpful so as to reduce the net affect of the readout noise because the signal is boosted before the readout noise is added. If the boundary of the filter coincides with the boundary of a modular device, then the gain from modular device to modular device would be changed. But if the filter boundary fell within the field of view of a particular modular device, then the gain of the EMCCD of that modular device would be changed for those parts of the image from outside the region of interest, i.e. the gain would be increased for those regions. This could enable dramatic expansion of the imaging system's dynamic range within the imaging field of one modular device. This intra-modular device gain variation might also be used at edges of patient fields or to better view parts of FOVs underneath bone or other attenuating material.

In a preferred embodiment of the present invention, the emission source is an x-ray converter and the detection device in each modular device is an EMCCD optically coupled with a FOT. In a more preferred embodiment, the x-ray converter is CsI(Tl). Unlike dynamic FPDs where there are both noise and speed limits that prevent pixels sizes from being smaller than 150-200 μm, EMCCDs typically have pixels in the range of 8-13 μm, thus very high resolution can easily be achieved. By using a FOT and selecting the taper ratio in the range of 2:1 to 6:1, the effective pixel size for an EMCCD with 8 μm pixels is 16-48 μm which is about as small as is merited by the limits of resolution of the typical thickness of a structured phosphor x-ray converter such as CsI(Tl) phosphor and realistic radiation exposure levels. Even then, binning for fluoroscopy may be necessary depending upon the application. The imaging system of the present invention is flexible enough to have a range of spatial resolutions including the capability for far better resolution than is currently available. To visualize tiny features not presently seen by current imaging system requires higher resolution rapid sequence detectors capable of both angiography and fluoroscopy, which the imaging system of the present invention is uniquely designed to provide.

While FPDs have no gain at the pixel to overcome the sizeable readout noise (2000+ electrons) experienced in transferring the signal off the pixel, EMCCDs have on-chip gain up to 2000 experienced by all charge packets from every pixel on the chip before the small readout noise (10 s of electrons) is added to the signal leaving the chip to the outside circuitry. In this way the effective readout noise compared to the image signal is negligible, and an imaging system of the present invention is quantum limited throughout its range of performance in both fluoroscopy and angiography even at low exposures of a few μR where FPDs are not.

The EMCCDs used in the preferred imaging system of the present invention are based on frame-transfer CCD architecture which means they are designed for and capable of 30 Mpixel/sec or greater readout rates. They can operate at 1000×1000 pixel real-time 30 fps readout for low or high level signals without binning. Moreover, unlike FPDs, the EMCCDs have neither lag nor ghosting.

Some FPDs with extended dynamic range have an extra capacitor at each pixel that allows 4× expansion of charge capacity; however, there is still 14 bit digitization for an apparent dynamic range of 16 bit with 14 bit significance. The preferred imaging systems of the present invention have a much larger dynamic range due to the on-chip gain-changing capability up to 2000 (˜9 bits). Current EMCCD cameras have typically 12 bit to 16 bit acquisition; however, the additional gain increases the signal relative to the noise and provides an addition 8 or 9 bit increase in dynamic range for a total of 20 to 25 bits.

Because the EMCCDs pixels are so fine, to achieve larger fields of view the chips are paired with fiber optic tapers and these modular devices are formed into an array or mosaic. As the design of the imaging system of the present invention is modular, it is inherently scaleable hence enabling flexible system field of view sizes and shapes. Higher resolution with the imaging system of the present invention is achieved by changing the fiber optic taper ratio and binning protocol.

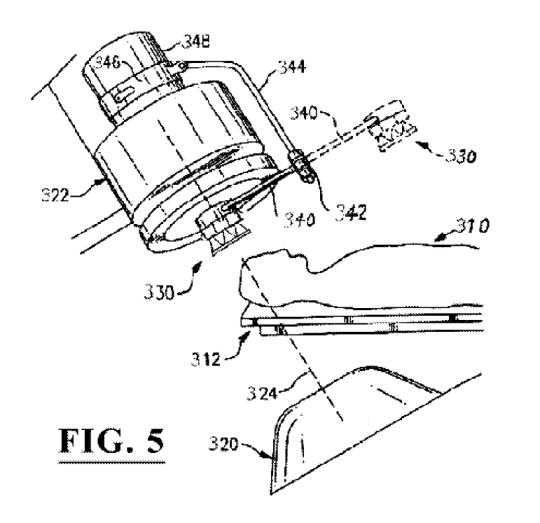

The imaging system of the present invention can be used in combination with flat panel devices (FPD) or x-ray image intensifiers, as shown in FIG. 5, or alone. Referring to FIG. 5, a patient 310 is resting on a table 312 or similar supporting surface and is located in proximity to a standard radiographic apparatus comprising an x-ray tube 320, which is a source of x-rays. In this embodiment, an x-ray detector 322 (e.g., image intensifier (XII), as depicted in FIG. 5, or FPD, not shown) is provided. In the situation illustrated in FIG. 5, the central ray or central axis 324 extending between x-ray tube 320 and x-ray detector 322 passes through the head of patient 310 for obtaining radiographic images at related locations in the patient's head. Other areas of the patient's body can of course be imaged by the system shown in FIG. 5.

The emission source and detection array 330 of the imaging system according to the present invention is shown in FIG. 5 moved into a position where it is in alignment or in operative position with respect to central ray 324. In addition, the image plane of detection array 330 is substantially parallel to and in close proximity to the image plane of x-ray detector 322. This is the operative position where detection array 330 is used to enable the operating physician to monitor an endovascular interventional procedure, such as in the head area of patient 310 in the situation illustrated in FIG. 5. Detection array 330 would be operatively connected to equipment including a CRT monitor or display (not shown) providing visual images of the procedure as it is taking place. Such monitors or displays and associated equipment are know to those skilled in the art. Networking of the detection array 330 would be achieved as described above.

Detection array 330 is carried by the x-ray detector 322 in a manner such that it can be moved to the broken like position shown in FIG. 5 where it is away from central ray or axis 324 when it is not in use. In the illustrative arrangement of FIG. 5, the detection array 330 is fixed to one end of an arm 340, the opposite end of which is pivotally connected by a mechanism 342 to one end of a second arm 344, the opposite end of which is fixed by a collar or suitable mounting bracket 346 to the smaller diameter neck position 348 of x-ray detector 322. Thus, arm 340 which carries detection array 330 is pivoted about an axis substantially parallel to central ray axis 324. Arm 344 can of course be mounted to other locations of the body or housing of x-ray detector 322. The arrangement of FIG. 5 is illustrative of various other ways detection array 330 can be supported and positioned according to the present invention (see, e.g., U.S. Pat. No. 6,285,739, which is hereby incorporated by reference in its entirety).

In the embodiment in which the imaging system of the present invention is used alone, x-ray detector 322 in FIG. 5 would be replaced by the emission source and detection array 330 and imaging would proceed as described above.

The imaging system of the present invention can be used in any non-destructive testing situation, preferably where things are moving so there is a need for dynamic imaging and where the light signal may be very low level requiring amplification or efficient light collection before the noise associated with bringing the signal from the sensor to the readout and digitizing devices is added. Applications suitable for the imaging system and method of the present invention include, but are not limited to, neuro- and cardio-vascular procedures such as endovascular image guided interventions (EIGI) for treating aneurysms and stenotic vessels deep in the cranial vasculature, diagnosis and treatment of coronary chronic total occlusion (CTO), as well as anti-angiogenic tumor treatment. In particular, application of the imaging system and method of the present invention to IGI procedures should enable the high resolution over a small FOV to improve IGI clinical accuracy and effectiveness. In neurovascular interventions, the imaging system and method should enable more accurate deployment of stents for treatment of stenoses and aneurysms on smaller vessels further into the Circle of Willis, more successful clot removal procedures for treatment of acute ischemic stroke using existing devices such as the Merci Retriever as well as innovation in newer, smaller, and hence more successful clot removal devices by allowing better guidance within smaller vessels for the fine structure of devices that cannot presently be well visualized. In cardiovascular interventions, the imaging system should allow more accurate treatment of coronary chronic total occlusion (CTO) by enabling the visualization and more accurate guidance of procedures for opening total or near-total occlusions. Also by improved visualization of vessel lumens, the imaging system and method should improve the diagnosis and accuracy for differentiating and treating soft or calcified plaque thereby reducing potential consequential stroke induced by debris resulting from the treatment. In other clinical areas such as cancer, the imaging system and method should improve mammographic CT and tomosynthesis by enabling the use of more lower-exposure views than are possible with current detectors assuming the total integral patient dose for a diagnostic study must be unchanged (see, Rudin et al., “New Light-Amplifier-Based Detector Designs for High Spatial Resolution and High Sensitivity CBCT Mammography,” SPIE vol. 6142, pp. 6142R1-11 (2006). In: Proceedings from Medical Imaging 2006: Physics of Medical Imaging, San Diego, Calif., paper #63 and Kwan et al., “Noise Assessment in a Dedicated Breast CT Scanner (abstract),” Program of 92nd Scientific Assembly and Annual Meeting of RSNA, Nov. 26-Dec. 1, (2006), Chicago, November (2006), scientific presentation SSK18-08, p. 463, which are hereby incorporated by reference in their entirety, for example, which indicate that the instrumentation noise limits for FPDs are inhibiting increasing the number of projection views to reduce sampling artifacts because of the inability to use FPDs at lower exposures). Additional cancer applications may be to improved visualization of the vascular bed of tumors to better guide the use of anti-angiogenic drug treatments. Such improved small vessel visualization may also help in the treatment of caudication when angiogenic drugs may be used so as to evaluate the success of new small vessel generation. Applications in small animal research should also be apparent because of the unique dynamic high resolution imaging capability of even the initial small-FOV imaging systems of the present invention. In the area of new diagnostic techniques, the imaging systems and method of the present invention may open up a whole new area of ROI imaging methods for both 2D and 3D-CT. It will be possible to use a large area imaging systems of the present invention for all current imaging requirements, but in addition, be able to reduce dose to all but an ROI which may be imaged at substantially higher resolution. The result would be a vast improvement in the efficacious utilization of patient dose to enable improved imaging of relevant regions yet within the context of the surrounding region, i.e. without tunnel vision. For 2D fluoroscopy, the imaging systems of the present invention with ROI filter will enable rapid switching from standard imaging modes to very high resolution ROI modes with a consequent advantage for almost all diagnostic and IGI procedures where dynamic imaging is used. Likewise, the new technology of ROI-CT enabled by the imaging systems of the present invention should have vast application to many diagnostic and IGI areas yet with minimal patient integral dose.

Additional new modalities involving region of interest (ROI) fluoroscopy, angiography, and cone beam computed tomography (CBCT), where the unique high resolution capabilities of the imaging system and method of the present invention can be used while maintaining lower integral dose to the patient, are encompassed. Applications in addition to EIGI procedures include mammographic CT and tomosynthesis and other imaging where the low noise characteristics of the imaging system of the present invention will enable increased number of lower dose views to reduce reconstruction artifacts.

Another application is low light level microscopy where dynamic phenomena are being viewed and hence where the use of inefficient optical lenses may be inadequate and need to be replaced by a more efficient light collection system such as that provided by the large area light sensing mosaic of the present invention. A further application is astronomy where there are low light requirements. The system, computer readable medium, and method of the present invention can be used in any desired low light application, since, with application of sufficient gain in the detector device, even single photon counting can be achieved.

### EXAMPLES

### Example 1

### Prototype Solid State X-Ray Imaged Intensifier (SSXII)

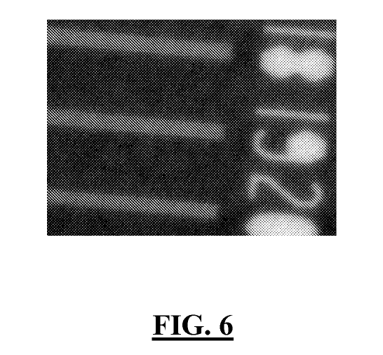

A prototype EMCCD camera system (Photonic Sciences Limited modified CoolView camera, East Sussex, UK) modified with a fiber-optic plate (FOP) window for the 1004×1002 TC285SPD chip that was used was created as described in Kuhls-Gilcrist et al., “The Solid-State X-ray Image Intensifier (SSXII): An EMCCD-Based X-ray Detector,” Proc. Soc. Photo. Opt. Instrum. Eng. Medical Imaging 6913-19 (2008), which is hereby incorporated by reference in its entirety. The EMCCD camera was delivered with a thin removable GOS phosphor and a few random small white spots were noticed on the images, which subsequently were found to be direct x-ray absorption in the EMCCD. The GOS was subsequently replaced with a 350 μm thick CsI(Tl) FOP module and the resulting images were free of these artifacts. The CsI module was optically coupled directly to the EMCCD FOP and images were obtained that exceeded expectations. For example, FIG. 6 demonstrates that even with a 350 μm thick CsI layer, all the patterns on a mammographic bar pattern out to 20 Lp/mm were visible even using 50 kVp with one inch thick acrylic attenuation in the beam.

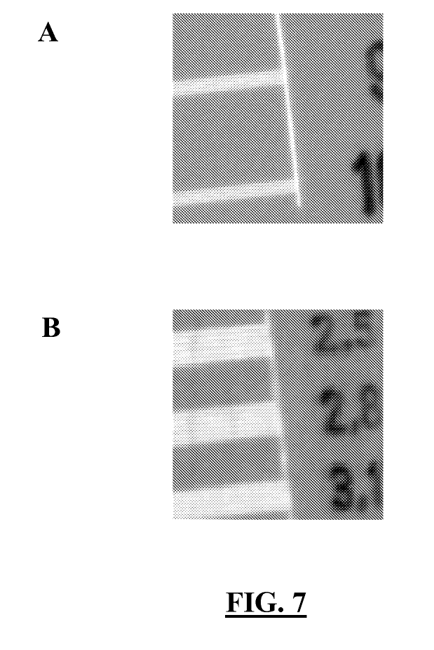

The prototype SSXII modular device was then compared with a standard state-of-the-art XII in its highest resolution mode for both angiographic and fluoroscopic modes through two inches of acrylic at precisely the same geometric configurations and the same x-ray exposure parameters with the object remaining fixed with respect to the x-ray focal spot. FIGS. 7A-B show the comparison for a standard radiographic bar pattern (Nuclear Associates Model 07-521, Carle Place, N.Y.). While the XII could barely visualize the 3.1 Lp/mm bars, the SSXII prototype modular device easily visualized the highest resolution 10 Lp/mm available on this test object.

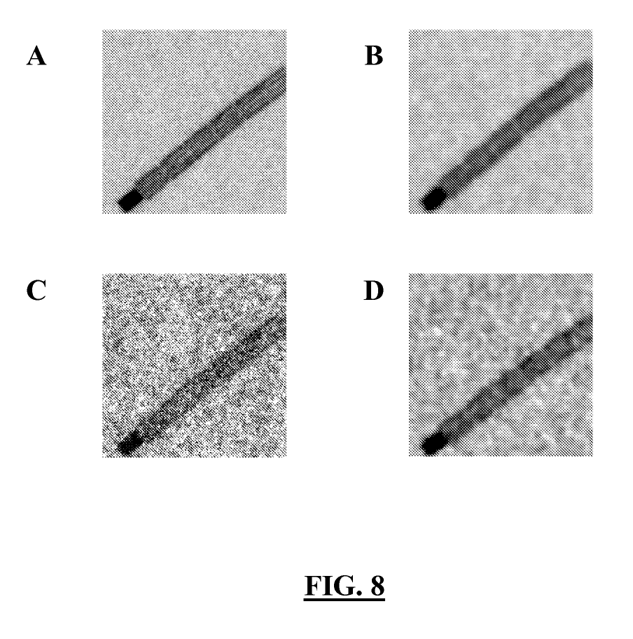

The two detectors were further compared during acquisition of rapid sequence images. Again, the identical set-up was used as described above to acquire FIG. 7A; however, now the exposure per frame was varied to be values that might be used for angiography (0.5 mR/frame) and for fluoroscopy with magnification mode (˜20 μR/frame). This comparison is shown in FIGS. 8A-D, for a single frame from each of the four runs, two for fluoroscopy and two for angiography (see also Kuhls et al., “Progress in Electron-Multiplying CCD (EMCCD) Based, High-Resolution, High-Sensitivity X-ray Detector for Fluoroscopy and Radiography,” In: Medical Imaging 2007, Physics of Medical Imaging, Hsieh et al., eds., Proc. of SPIE Vol. 6510, paper 6510-47, (2007), which is hereby incorporated by reference in its entirety). Although the same exposure parameters were used as determined by the automatic controls of the commercial system (Toshiba Infinix), these technique parameters are not optimal for the higher resolution SSXII since it would be expected that higher quality fluoroscopy could well warrant increased exposure within the region of interest, especially for use during crucial phases of an intervention. Additionally, in this experiment, temporal filtering was not introduced for the SSXII images during fluoroscopy while the commercial vendor does have such a substantial temporal filter which essentially decreases the noise by introducing persistence. Nevertheless, even at the standard fluoroscopic exposure levels, the SSXII demonstrated improved delineation especially of the edges and corner of the opaque rectangular marker of the deployment catheter. Also, obviously in the angiogram comparison, the SSXII images are far superior in that only with the SSXII are the struts of the undeployed stent clearly visualized.

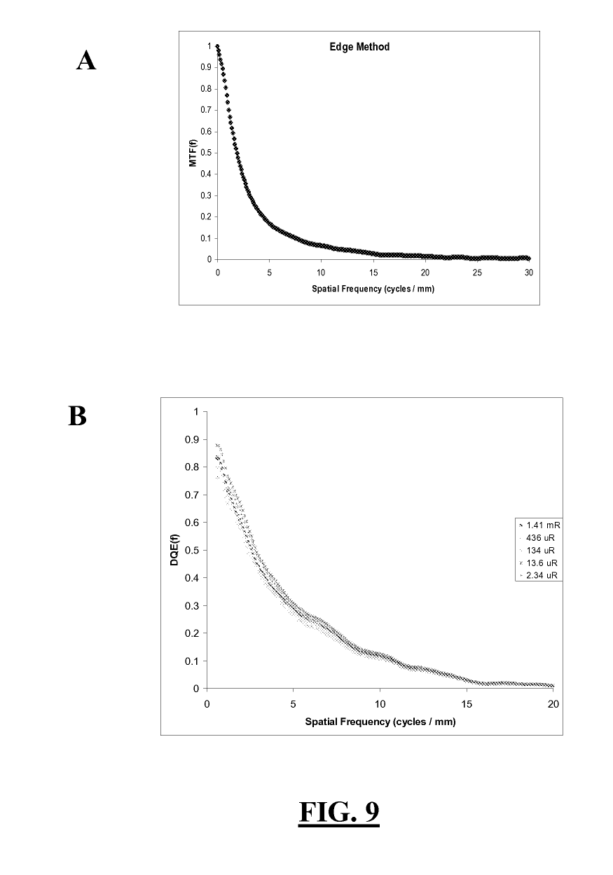

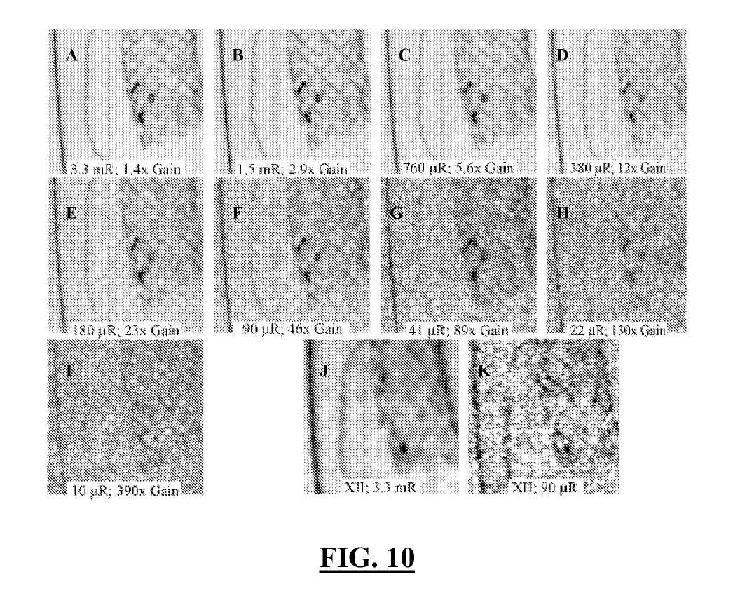

Also, preliminary experimental measurements of the MTF and DQE of the SSXII were performed. The MTF using the edge method is shown in FIG. 9A and indicates 12% at 6.6 Lp/mm, 6% at 10 Lp/mm, and 3% at 14.5 Lp/mm. One of the problems encountered was that the edge appeared to have enough non-uniformities so as to make accurate measurements at the very highest spatial frequencies difficult. This might help explain why it was possible to see the 20 Lp/mm in FIG. 6 even though the measured MTF at 20 Lp/mm appeared to be 1.3%. The measured DQE is given in FIG. 9B for a variety of detector exposures from fluoroscopy mode to radiographic mode. The gain of the EMCCD was increased to compensate for the reduction in exposure in order to maintain a constant recorded signal value. Other than experimental fluctuation, there does not appear to be much change even at the lower exposures. This shows that the instrumentation noise can be made negligible compared to the quantum noise even at low exposures and indicates that the SSXII always runs in quantum limited operation. To demonstrate the effect of the large range of exposure that the SSXII is capable of operating at, the same set of objects was used and the gain and exposure per frame was varied so as to maintain the same output values. The set of images appears in FIGS. 10A-K. The values range from fluoroscopic exposures appropriate to lower resolution standard XII and FPD systems all the way to radiographic exposures. This comparison indicates that boosting the exposure to improve the visualization of small vessels and interventional endovascular devices such as stents may be justifiable for the SSXII depending upon the degree of quantum noise the clinician is willing to accept in relation to the signal from the feature of interest.

### Example 2

### System Construction for a Single Modular Device

To have the most flexibility in building an optimized imaging system, it must be possible to control the design aspects at the component and system level. Thus, construction of a prototype system from components that could be extrapolated to the final system was initiated. A modular device based on a CCD chip, the Texas Instruments TC237B, that has similar architecture to readily available EMCCD chips, the TI TC247SPD and the TC253SPD, was created. The TC253SPD is a frame transfer chip nominally with 680×500 pixels of which 658H×496V are active with 7.4 μm square pixels while the TC247SPD has 10 μm pixels. The TC285SPD EMCCD has 1004×1002 pixels. All have similar clocking pulse specifications; however, the TC247SPD, TC253SPD, and TC285SPD have additional multiplying elements and hence additional pins for the control voltage that determines the “charge carrier multiplication” or gain as well as for the optional Peltier cooler that can be supplied integral with the chip package. In this prototype, the detector device was a TI TC237B CCD chip which was plugged into an in-house built mother-board which had a CCD clock driver circuit and on which was mounted a Pegasus Board containing the Xilinx Spartan 2, XC2S200PQ208, FPGA that was used to control the clocking pulses for the CCD control and readout. Output from the CCD went to a 12-bit A to D converter (“ADC”) on an EXAR XRD 98L63 Evaluation Board, which was also controlled by timing pulses generated in the FPGA. The output from the ADC were then routed to a data acquisition board, the TI starter kit with a DSP core TMS320C6416T-1000 also containing an external memory starter kit from Micron MT48LC2M32B2TG-6 to buffer one demonstration frame which was then transferred to a PC via a serial port.

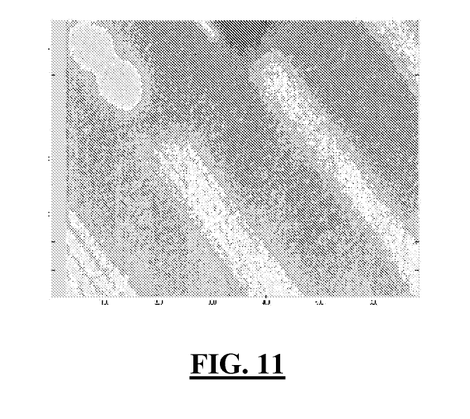

The recording and display part of the prototype was improvised so that an image could be acquired and displayed on a PC. A bar pattern placed somewhat close to the CCD and exposed using a crude distributed light source was imaged. Without much emphasis on the optics, an adequate demonstration image as indicated in FIG. 11 was obtained.

### Example 3

### 2×2 SSXII Array

To achieve larger fields of view, an array of modular devices as indicated in FIG. 2 will be designed such that the phosphor layer is contiguous, just as in all current XII and FPD imagers. The rationale for the 2×2 array using Photonic Science Ltd. (East Sussex, UK) or similar cameras is that the PSL camera was shown to work well in Example 1. A National Instruments (NI) 1429 frame grabber board, which can achieve 30 fps for 1024×1024 matrix images with no binning, will be used (the NI 1430 has two CameraLink inputs per board) together with a high speed PC to achieve 30 fps acquisition rates for the SSXII 2×2 array.

To build the 2×2 SSXII array, the four cameras will be mounted onto an array of FOTs. One way to assure that there is the smallest separation or image area loss between modular devices is to pre-assemble the FOTs into an array by bonding them together after the sides are ground but prior to grinding the input surface to enable either plating of the CsI phosphor or coupling to the FOP on which the structured phosphor is grown. For convenience and flexibility, the phosphor module with its own FOP and the pre-assembled FOT array will be purchased separately; however, there are advantages to having the phosphor deposited directly on the FOT array input surface and elimination of the FOP. In particular, although there will still be a small loss of image information at the interface between FOT edges, at standard FOT grinding precisions, such a loss of ˜2 mils (50 μm) per FOT is about 1 pixel for 2:1 binning and hence can be corrected by software interpolation fairly routinely. Once the phosphor module and FOT array are assembled, the four cameras each with its FOP or small-FOT window can be optically coupled to the larger FOT outputs. The four cameras will be initially mechanically aligned using interactive images of test exposures and clamped in place when adequate alignment of a fraction of a degree is achieved. The remaining misalignments and distortions will be corrected with software (Hamwi et al., “Distortion and orientation correction of tiled EMCCD detector images,” Proceeding of CARS 2007, Berlin, GE, Jun. 27-30, (2007), which is hereby incorporated by reference in its entirety). During the alignment process it will also be determined how many and which outer pixel rows and columns recorded by the EMCCD chip fall outside the active irradiation area, and must be ignored when forming the composite image. The manufacture of the FOTs will be carefully specified so that the input square area divided by the taper ratio must be very slightly less than the 8 mm active area of the EMCCD. If the input area of the taper is too large then there will be gaps between the modular devices which are not imaged. If the area is too small then too many of the EMCCD rows and columns will be wasted, even with careful alignment, since the outer parts of the EMCCD chip active area will not be illuminated. Since the machining of the FOTs is specified by the manufacturer to within a few equivalent pixels which can be done after an exact determination of the taper ratio, then the burden to reduce the lost outer pixels falls on the ability to align the chips prior to software corrections. A simple calculation indicates that for a loss of 10 out of the 1000 pixels in a row or column, the equivalent rotation is 0.57°. With the placement methods previously indicated, at least this accuracy should easily be achieved resulting in losses due to rotation and translation errors of no more than a few tens of pixels per row.

The general principle behind the network design for acquiring data from the array of modular devices was outlined above. For the 2×2 array, the network will be somewhat simpler than for the larger SSXII built from components. Since the PSL cameras are only capable of 31.25 fps at 2:1 binning, when a frame rate of 30 fps is required, each camera's output will be mapped to a quadrant of the display memory matrix using the frame grabbers. In this way, 30 fps for the total 2×2 array will be displayed. When zoom-mode is used for ROI high-resolution imaging, 1004×1002 matrix recording up to 16.1 fps will be used for the selected camera in one of the quadrants. For larger arrays, a more sophisticated network will be implemented as well as higher speed made possible for single modular devices because the Tl chips are specified to run at 35 MHz.

With four separate modular devices, there will initially be manual controls to set the EMCCD gains for each during fluoroscopy and angiography or CT mode. During set-up, the four gains will be balanced so that the gray levels are uniform across the modular device boundaries. A single gain control as designated in the GUI will then be able to be used so that all four modular device gains maintain balance. Eventually, the automatic gain control, with feedback from the pixel values, will be implemented while balance across modular devices is maintained. Once again just as for the single modular device discussed above, the gain will be lowered for angiography mode. Additionally, the need for any post processing rebalancing following angiography acquisition will be evaluated and implemented if necessary.

Commercial fluoroscopy systems even based on XII-CCD combinations are provided with temporal filtering which reduces the quantum noise. Although the EMCCDs have no inherent lag, such a temporal filter will be implemented especially when comparing the developmental systems with commercial fluoroscopy systems. This will be done with a dedicated DSP board and use similar weighting values as are used in present commercial systems. By measuring the digital values of a moving test pattern such as the one in the NEMA cardiac phantom, temporal recursion weighting factors of ˜⅛ have been found. For angiography, this persistence is turned off since temporal averaging might blur the angiogram. Additionally, reduction of quantum noise for these higher exposure-per-frame modes is not as crucial compared to risks of motion induced blurring.

One of the unique features of EMCCDs is the capability for gain changing using simple voltage control. If this gain change is implemented during the actual frame readout of a modular device, then it is possible to achieve larger dynamic range within the field of view of one modular device. Thus, if ROI filters are used to reduce patient exposure to all regions except an ROI and if the border between the high exposure ROI and the much lower exposure filtered-outside region were to fall in the middle of the FOV of one modular device, then one could adjust the EMCCD chip gain dynamically so as to increase it for the outside regions and reduce it for the ROI. Such a gain change will be implemented between row readouts to achieve the desired sharp change in gain for horizontal boundaries (parallel to the readout direction). For vertical boundaries, only a more gradual gain change is possible because there are 400 multiplying elements contributing to the gain for all 1004 pixels in a row, hence a sudden change in gain for all the elements would result in different gains to pixels for the current row being read out. It would be necessary to convolve the 1004 pixel values of a row as it is read out with the 400 element dynamic gain values.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. An imaging system comprising:
a detection array comprising an array of modular devices positioned such that one or more modular devices are capable of simultaneously receiving at least a portion of a first output signal from an emission source of an object to be imaged, each of the modular devices comprising a detector device, wherein each of the modular devices in the array is capable of converting at least a portion of the first output signal to a second output readout; and
a processing unit operatively coupled to the detection array and capable of processing the second output readouts of one or more of the modular devices, wherein said processing comprises adjusting the relationship between any combination of a second output collection rate for each active modular device, a second output readout rate, a frame rate for each active modular device, binning factor, and a number of active modular devices determining an image field of view to obtain an image of the object.

2. The system according to claim 1, wherein the detection array has a frame rate of no more than 30 frames per second.

3. The system according to claim 1, wherein each active modular device has a frame size of from about 1000×1000 to about 1024×1024 pixels.

4. The system according to claim 1, wherein the emission source is a radiation converter.

5. The system according to claim 4, wherein the emission source is a CsI(Tl) phosphor x-ray converter.

6. The system according to claim 1, wherein the detector device is selected from the group consisting of an electron multiplying charge coupled device, a charge coupled device, a photodiode array, a phototransistor array, photomultiplier tubes, and an avalanche photodiode array.

7. The system according to claim 1, wherein each modular device comprises a fiber optic taper optically coupled at a first end to the emission source and at a second end to the detector device.

8. The system according to claim 1, wherein each modular device comprises a cooling device positioned to cool the detector device.

9. The system according to claim 1, wherein processing comprises increasing the second output collection rate by binning a second output in one or more of the detector devices.

10. The system according to claim 1, wherein processing comprises binning the second output readouts of one or more of the modular devices in the processing unit.

11. The system according to claim 1, wherein processing comprises reading the second output readouts of a portion of the modular devices under conditions effective to obtain a high resolution image of a region of interest within the field of view.

12. The system according to claim 1, wherein the frame rate, binning factor, and data acquisition rate are constant and processing comprises increasing the second output collection rate by increasing binning and increasing the number of active modular devices.

13. The system according to claim 1, wherein the frame rate, binning factor, and data acquisition rate are constant and processing comprises decreasing the second output collection rate by decreasing binning and decreasing the number of active modular devices.

14. The system according to claim 1, wherein the number of active modular devices and data acquisition rate are constant and processing comprises increasing the second output collection rate by increasing binning and increasing the frame rate.

15. The system according to claim 1 further comprising:
one or more analog-to-digital converters operatively coupled to the detection array and processing unit to convert each of the second output readouts to a digital output comprising multiple units of data prior to processing by the processing unit.

16. The system according to claim 15, wherein the processing unit reads a first unit of the digital output of each modular device sequentially followed by each remaining unit of the digital output of each modular device sequentially under conditions effective to obtain the image within the field of view.

17. The system according to claim 15, wherein the processing unit reads the digital output comprising multiple units of data for a first modular device followed sequentially by the digital outputs for each remaining modular device under conditions effective to obtain the image within the field of view.

18. The system according to claim 1, wherein the detector device is an electron multiplying charge coupled device and processing further comprises:
increasing gain in one modular device relative to one or more other modular devices.

19. The system according to claim 1, wherein the detector device is an electron multiplying charge coupled device and processing further comprises:
increasing gain on a first portion of a modular device relative to a second portion of the modular device.

20. An imaging method comprising:
positioning a detection array to receive a first output signal from an emission source of an object to be imaged, wherein the detection array comprises an array of modular devices positioned such that one or more modular devices are capable of simultaneously receiving at least a portion of the first output signal, each of said modular devices comprising a detector device;
converting at least a portion of the first output signal to a second output readout with one or more of the modular devices; and
processing the second output readouts of one or more of the modular devices, wherein said processing comprises adjusting the relationship between any combination of a second output collection rate for each active modular device, a second output readout rate, a frame rate for each active modular device, binning factor, and a number of active modular devices determining an image field of view to obtain an image of the object.

21. The method according to claim 20, wherein the detection array has a frame rate of no more than 30 frames per second.

22. The system according to claim 20, wherein each active modular device has a frame size of from about 1000×1000 to about 1024×1024 pixels.

23. The method according to claim 20, wherein the emission source is a radiation converter.

24. The method according to claim 23, wherein the emission source is a CsI(Tl) phosphor x-ray converter.

25. The method according to claim 20, wherein the detector device is selected from the group consisting of an electron multiplying charge coupled device, a charge coupled device, a photodiode array, a phototransistor array, photomultiplier tubes, and an avalanche photodiode array.

26. The method according to claim 20, wherein each modular device comprises a fiber optic taper optically coupled at a first end to the emission source and at a second end to the detector device.

27. The method according to claim 20, wherein each modular device comprises a cooling device positioned to cool the detector device.

28. The method according to claim 20, wherein processing comprises increasing the second output collection rate by binning the second output in one or more of the detector devices.

29. The method according to claim 20, wherein processing comprises binning the second output readouts of one or more of the modular devices in the processing unit.

30. The method according to claim 20, wherein processing comprises reading the second output readouts of a portion of the modular devices under conditions effective to obtain a high resolution image of a region of interest within the field of view.

31. The method according to claim 20, wherein the frame rate, binning factor, and data acquisition rate are constant and processing comprises increasing the second output collection rate by increasing binning and increasing the number of active modular devices.

32. The method according to claim 20, wherein the frame rate, binning factor, and data acquisition rate are constant and processing comprises decreasing the second output collection rate by decreasing binning and decreasing the number of active modular devices.

33. The method according to claim 20, wherein the number of active modular devices and data acquisition rate are constant and processing comprises increasing the second output collection rate by increasing binning and increasing the frame rate.

34. The method according to claim 20 further comprising:
one or more analog-to-digital converters operatively coupled to the detection array and processing unit to convert each of the second output readouts to a digital output comprising multiple units of data prior to processing by the processing unit.

35. The method according to claim 34, wherein the processing unit reads a first unit of the digital output of each modular device sequentially followed by each remaining unit of the digital output of each modular device sequentially under conditions effective to obtain the image within the field of view.

36. The method according to claim 34, wherein the processing unit reads the digital output comprising multiple units of data for a first modular device followed sequentially by the digital outputs for each remaining modular device under conditions effective to obtain the image within the field of view.

37. The method according to claim 20, wherein the detector device is an electron multiplying charge coupled device and processing further comprises:
increasing gain in one modular device relative to one or more other modular devices.

38. The method according to claim 20, wherein the detector device is an electron multiplying charge coupled device and processing further comprises:
increasing gain on a first portion of a modular device relative to a second portion of the modular device.

39. A computer readable medium having stored thereon instructions for imaging an object comprising machine executable code which when executed by at least one processor, causes the processor to perform steps comprising:
receiving a second output readout from one or more modular devices in a detection array, wherein the detection array comprises an array of the modular devices positioned such that one or more modular devices are capable of simultaneously receiving at least a portion of a first output signal from an emission source of an object to be imaged, each of said modular devices comprising a detector device, wherein each of the modular devices in the array is capable of converting at least a portion of the first output signal to the second output readout; and
processing the second output readouts of one or more of the modular devices, wherein said processing comprises adjusting the relationship between any combination of a second output collection rate for each active modular device, a second output readout rate, a frame rate for each active modular device, binning factor, and a number of active modular devices determining an image field of view to obtain an image of the object.

40. The computer readable medium according to claim 39, wherein the detection array has a frame rate of no more than 30 frames per second.

41. The computer readable medium according to claim 39, wherein each active modular device has a frame size of from about 1000×1000 to about 1024×1024 pixels.

42. The computer readable medium according to claim 39, wherein processing comprises increasing the second output collection rate by binning the second output in one or more of the detector devices.

43. The computer readable medium according to claim 39, wherein processing comprises binning the second output readouts of one or more of the modular devices in the processing unit.

44. The computer readable medium according to claim 39, wherein processing comprises reading the second output readouts of a portion of the modular devices under conditions effective to obtain a high resolution image of a region of interest within the field of view.

45. The computer readable medium according to claim 39, wherein the frame rate, binning factor, and data acquisition rate are constant and processing comprises increasing the second output collection rate by increasing binning and increasing the number of active modular devices.

46. The computer readable medium according to claim 39, wherein the frame rate, binning factor, and data acquisition rate are constant and processing comprises decreasing the second output collection rate by decreasing binning and decreasing the number of active modular devices.

47. The computer readable medium according to claim 39, wherein the number of active modular devices and data acquisition rate are constant and processing comprises increasing the second output collection rate by increasing binning and increasing the frame rate.

48. The computer readable medium according to claim 39, wherein the processing unit reads a first unit of digital output of each modular device sequentially followed by each remaining unit of digital output of each modular device sequentially under conditions effective to obtain the image within the field of view.

49. The computer readable medium according to claim 39, wherein the processing unit reads a digital output comprising multiple units of data for a first modular device followed sequentially by digital outputs for each remaining modular device under conditions effective to obtain the image within the field of view.

50. The computer readable medium according to claim 39, wherein processing comprises increasing gain in one modular device relative to one or more other modular devices.

51. The computer readable medium according to claim 39, wherein processing comprises increasing gain on a first portion of a modular device relative to a second portion of the modular device.
